(19) United States
(12) Patent Application Publication
(10) Pub. No.: US 2003/0011422 A1
(43) Pub. Date: Jan. 16, 2003

(54) Virtual zener diode

(76) Inventor: Mel Bazes, Haifa (IL)

Correspondence Address: Eitan, Pearl, Latzer & Cohen-Zedek, One Crystal Park, Suite 210, 2011 Crystal Drive, Arlington, VA, 22202-3709, US

(21) Appl. No.: 09/904,607

(22) Filed: Jul. 16, 2001

(51) Int. Cl. G05F 1/10

(52) U.S. Cl. 327/540

(57) ABSTRACT

Apparatus including a virtual zener diode circuit including a complementary metal oxide semiconductor (CMOS) circuit that mimics an operation of a true zener diode.

### FIELD OF THE INVENTION

The present invention relates generally to the regulation of power supplies for circuits, and particularly to a virtual zener diode that may provide a regulated and noise-free power supply for complementary metal oxide semiconductor (CMOS) circuits.

### BACKGROUND OF THE INVENTION

Zener diodes may be used to generate a relatively constant, regulated voltage. A zener diode may be biased in normal operation as shown in FIG. 1. A zener diode 5 may receive a supply voltage V_{cc} and have an output voltage Vₒᵤₜ. A biasing resistor 7 may be connected between the zener diode 5 and the supply voltage V_{cc}. The zener diode 5 may be grounded. As is known in the art, the output voltage Vₒᵤₜ may be equal to the zener diode breakdown voltage and may be substantially independent of the resistance value of the biasing resistor 7.

The zener diode output Vₒᵤₜ may be used to implement a simple regulator, as illustrated in FIG. 2. The output of the zener diode 5 may provide a regulated supply for a load 6. A decoupling capacitor 8 may be connected in parallel with the zener diode 5 and the load 6. The decoupling capacitor 8 may filter out noise generated by the load 6 or the supply voltage V_{cc}.

A disadvantage of prior art linear or switched voltage regulators is that the components of the voltage regulator must be capable of operating from the high-voltage main supply in order to step-down the supply voltage to the level of the output voltage.

### BRIEF DESCRIPTION OF THE DRAWINGS

The present invention will be understood and appreciated more fully from the following detailed description taken in conjunction with the appended drawings in which:

FIG. 1 is a schematic illustration of biasing of a zener diode;

FIG. 2 is a schematic illustration of a zener diode voltage regulator;

FIG. 3 is a schematic illustration of a virtual zener diode circuit, in accordance with an embodiment of the invention;

FIG. 4 is a schematic illustration of a virtual zener diode voltage regulator, in accordance with an embodiment of the invention; and

Fig, 5 is a schematic illustration of a virtual zener diode circuit, in accordance with another embodiment of the invention.

### DETAILED DESCRIPTION OF THE PRESENT INVENTION

In the following detailed description, numerous specific details are set forth in order to provide a thorough understanding of the invention. However, it will be understood by those skilled in the art that the present invention may be practiced without these specific details. In other instances, well-known methods, procedures, components and circuits have not been described in detail so as not to obscure the present invention.

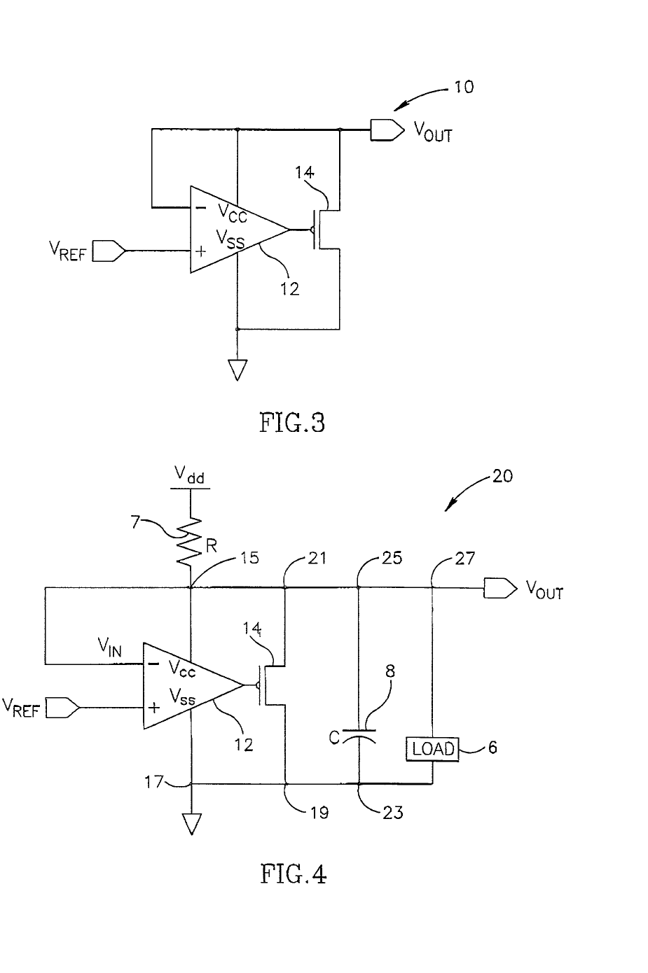

Reference is now made to FIG. 3, which illustrates a virtual zener diode circuit 10 in accordance with an embodiment of the invention.

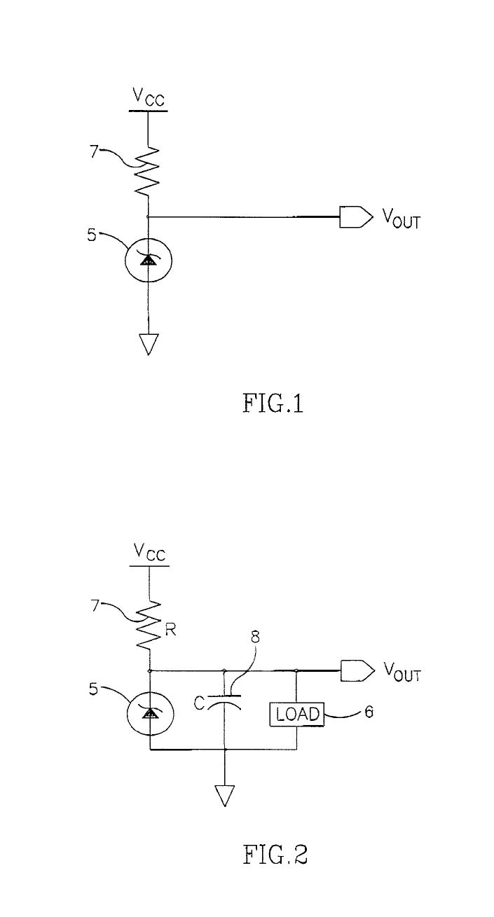

Virtual zener diode circuit 10 may comprise a complementary metal oxide semiconductor (CMOS) circuit that mimics the operation of a true zener diode, such as the zener diode 5 of FIGS. 1 and 2. In one embodiment of the invention, the virtual zener diode circuit 10 may comprise an operational amplifier (OA) 12 connected to a driver device 14. Operational amplifier 12 may comprise an operational transconductance amplifier (OTA). Driver device 14 may comprise a p-type output driver device.

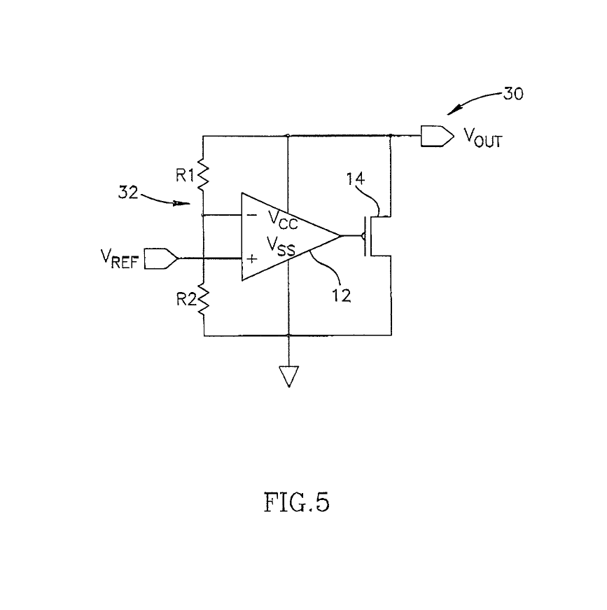

Reference is now additionally made to FIG. 4, which illustrates the virtual zener diode circuit 10 as part of a virtual zener diode voltage regulator 20, in accordance with an embodiment of the invention. OA 12 may receive an input from V_{ref} and from Vᵢₙ, and may receive its V_{SS} supply at a node 17. OA 12 may receive its V_{cc} supply at a node 15, which is connected to a voltage V_{dd} through biasing resistor 7. Driver device 14 may be connected to node 17 via a node 19, and may also be connected to node 15 via a node 21. A decoupling capacitor 8 may be connected in parallel to driver device 14 between nodes 23 and 25. A load 6 may be connected between node 23 and a node 27. Nodes 15, 21, 25 and 27 may be connected to an output voltage Vₒᵤₜ Nodes 17, 19 and 23 may be connected to ground.

Through negative feedback, OA 12 may force Vₒᵤₜ to be equal to V_{ref} within a small error, due to the finite value of the amplification of operational amplifier 12.

In one embodiment of the invention, the inputs V_{ref} and Vᵢₙ to OA 12 may be at generally the same voltage as its supply voltage V_{cc}. In such an embodiment, OA 12 may comprise an OTA adapted to operate with a common-mode input voltage equal to or exceeding its supply voltage V_{cc}. An example of such an OTA may be the OTA described in U.S. patent application Ser. No. 09/547,748 of the present applicant/assignee, filed Apr. 12, 2000, entitled “A High Gain, Very Wide Common-Mode Range, Self-Biased Operational Amplifier”, the disclosure of which is incorporated herein by reference. Such an OTA has high gain while accepting rail-to-rail common-mode input voltages, such as common-mode input voltages ranging from 0V up to the supply voltage V_{cc}.

The virtual zener diode voltage regulator 20 may be used to generate regulated noise-free supplies. The following is an illustrative example, although it is emphasized that the present invention is not limited to this example. The virtual zener diode voltage regulator 20 may be used to generate a regulated noise-free 1.2V supply from a 1.8V noisy supply for analog circuitry. Since all voltages inside the virtual zener diode voltage regulator 20 are 1.2V or less, low-voltage devices may be used to implement the zener diode voltage regulator 20, even though such devices may not be able to operate with the high voltage 1.8V supply. Moreover, since no devices are connected to the noisy 1.8V supply, there may be very little noise-coupling from the noisy 1.8V supply to the output 1.2V supply. After low-pass filtering, the output of the virtual zener diode voltage regulator may be essentially noise-free.

Reference is now made to FIG. 5, which illustrates a virtual zener diode circuit 30 in accordance with an embodiment of the invention. Virtual zener diode circuit 30 may be similar to virtual zener diode circuit 10, except that virtual zener diode circuit 30 may employ a resistive divider 32 connected to OA 12. Resistive divider 32 may comprise without limitation at least two resistors R1 and R2. Unlike virtual zener diode circuit 10, in virtual zener diode circuit 30 the reference voltage V_{ref} may be less than the output voltage Vₒᵤₜ by dividing Vₒᵤₜ with the resistive divider 32.

With the resistive divider 32, Vₒᵤₜ may be related to V_{ref} by the formula:

Vₒᵤₜ=V_{ref}(1+(R1/R2))

For example, if R1=R2 =R, and Vₒᵤₜ=1.2 V, then V_{ref}=0.6 V (=0.5V_{cc}).

As mentioned hereinabove, in one embodiment of virtual zener diode circuit 10, OA 12 may comprise an OTA adapted to operate with a common-mode input voltage equal to or exceeding the supply voltage V_{cc}. In contrast, in an embodiment of virtual zener diode circuit 30 wherein V_{ref} is less than Vₒᵤₜ, OA 12 may comprise an OTA adapted to operate with a common-mode input voltage of less than V_{cc}, such as in the above example, 0.5V_{cc}.

It will be appreciated by persons skilled in the art that the present invention is not limited by what has been particularly shown and described herein above. Rather the scope of the invention is defined by the claims that follow:

What is claimed is:

1. Apparatus comprising:
a virtual zener diode circuit comprising a complementary metal oxide semiconductor (CMOS) circuit that mimics an operation of a true zener diode.

2. Apparatus according to claim 1 wherein said virtual zener diode circuit comprises an operational amplifier (OA) connected to a driver device.

3. Apparatus according to claim 2 wherein said OA comprises an operational transconductance amplifier (OTA).

4. Apparatus according to claim 2 wherein said driver device comprises a p-type output driver device.

5. Apparatus according to claim 2 wherein said OA receives a supply voltage through a biasing resistor, and wherein said OA receives an input from an input reference voltage V_{ref} and from another input voltage Vᵢₙ.

6. Apparatus according to claim 5 wherein said OA is adapted to force an output voltage Vₒᵤₜ of said virtual zener diode circuit to be approximately equal to V_{ref} through negative feedback.

7. Apparatus according to claim 5 wherein the inputs V_{ref} and Vᵢₙ to said OA are generally equal to the OA supply voltage.

8. Apparatus according to claim 5 wherein said OA comprises an OTA adapted to operate with a common-mode input voltage equal to at least its supply voltage.

9. Apparatus according to claim 2 wherein said OA receives a supply voltage through a biasing resistor connected at a first node, and wherein said OA receives an input from an input reference voltage V_{ref} and from another input voltage Vᵢₙ, and is grounded at a second node;
wherein said driver device is connected to said second node via a third node, and is connected to said first node via a fourth node, and whose input is connected to the output of said OA;
wherein a decoupling capacitor is connected in parallel to said driver device between fifth and sixth nodes, said fifth node being connected to said second node and said sixth node being connected to said first node; and
wherein a load is connected between a seventh node and an eighth node, said seventh node being connected to said second node and said eighth node being connected to said first node.

10. Apparatus according to claim 9 in which said driver device is a p-type MOS device.

11. Apparatus according to claim 10 in which the drain of said p-type MOS device comprises said third node, the source of said p-type MOS device comprises said fourth node, and the gate of said p-type MOS device comprises said input.

12. Apparatus according to claim 2 wherein said OA is connected to a resistive divider.

13. Apparatus according to claim 12 wherein said resistive divider is adapted to divide down an output voltage Vₒᵤₜ of said vital zener diode circuit so as to obtain an input reference voltage V_{ref} which is less than the output voltage Vₒᵤₜ.

14. Apparatus according to claim 12 wherein said OA comprises an OTA adapted to operate with a common-mode input voltage less than a supply voltage of said OA.

15. Apparatus according to claim 12 wherein said resistive divider comprises at least two resistors R1 and R2.

16. Apparatus according to claim 13 wherein said resistive divider comprises at least two resistors R1 and R2, and Vₒᵤₜ=V_{ref}(1+(R1/R2)).

17. A method comprising:
mimicking an operation of a true zener diode with a virtual zener diode circuit that comprises a complementary metal oxide semiconductor (CMOS) circuit.

18. The method according to claim 17 wherein said mimicking comprises constructing said virtual zener diode circuit with an operational amplifier (OA) connected to a driver device.

19. The method according to claim 17 wherein said mimicking comprises constructing said virtual zener diode circuit with an operational transconductance amplifier (OTA) connected to a driver device.

20. The method according to claim 18 wherein said mimicking comprises constructing said virtual zener diode circuit such that said OA receives a supply voltage through a biasing resistor, and wherein said OA receives an input from V_{ref} and from Vᵢₙ.

21. The method according to clam 18 and further comprising forcing an output voltage Vₒᵤₜ of said virtual zener diode circuit to be approximately equal to V_{ref} through negative feedback.

22. The method according to claim 18 wherein said mimicking comprises dividing down an output voltage Vₒᵤₜ of said virtual zener diode circuit so as to obtain an output voltage Vₒᵤₜ which is greater than an input reference voltage V_{ref}.
